(19) United States
(12) Patent Application Publication
(10) Pub. No.: US 2016/0294213 A1
(43) Pub. Date: Oct. 6, 2016

(54) EMERGENCY POWER SYSTEM

(71) Applicant: Vaunia Morrison, Laurel, MD (US)

(72) Inventor: Vaunia Morrison, Laurel, MD (US)

(21) Appl. No.: 14/677,135

(22) Filed: Apr. 2, 2015

(51) Int. Cl. H02J 9/06; F25B 27/00

(52) U.S. Cl. CPC H02J 9/061; F25B 27/00

(57) ABSTRACT

An emergency power system for maintaining power to a refrigeration unit during a power outage includes a refrigeration unit to contain food items and maintain the food items at a cooled temperature to preserve the food items. The refrigeration unit is electrically coupled to a power source. A backup apparatus provides electrical power to the refrigeration unit in the event of failure of the power source such that the refrigeration unit maintains the food items at the cooled temperature.

### BACKGROUND OF THE DISCLOSURE

1. Field of the Disclosure

The disclosure relates to emergency power devices and more particularly pertains to a new emergency power device for maintaining power to a refrigeration unit during a power outage.

### SUMMARY OF THE DISCLOSURE

An embodiment of the disclosure meets the needs presented above by generally comprising a refrigeration unit to contain food items and maintain the food items at a cooled temperature to preserve the food items. The refrigeration unit is electrically coupled to a power source. A backup apparatus provides electrical power to the refrigeration unit in the event of failure of the power source such that the refrigeration unit maintains the food items at the cooled temperature.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of an emergency power system according to an embodiment of the disclosure.

FIG. 2 is a back perspective view of an embodiment of the disclosure.

FIG. 3 is a perspective view of an embodiment of the disclosure.

FIG. 4 is a schematic view of an embodiment of the disclosure.

### DESCRIPTION OF THE PREFERRED EMBODIMENT

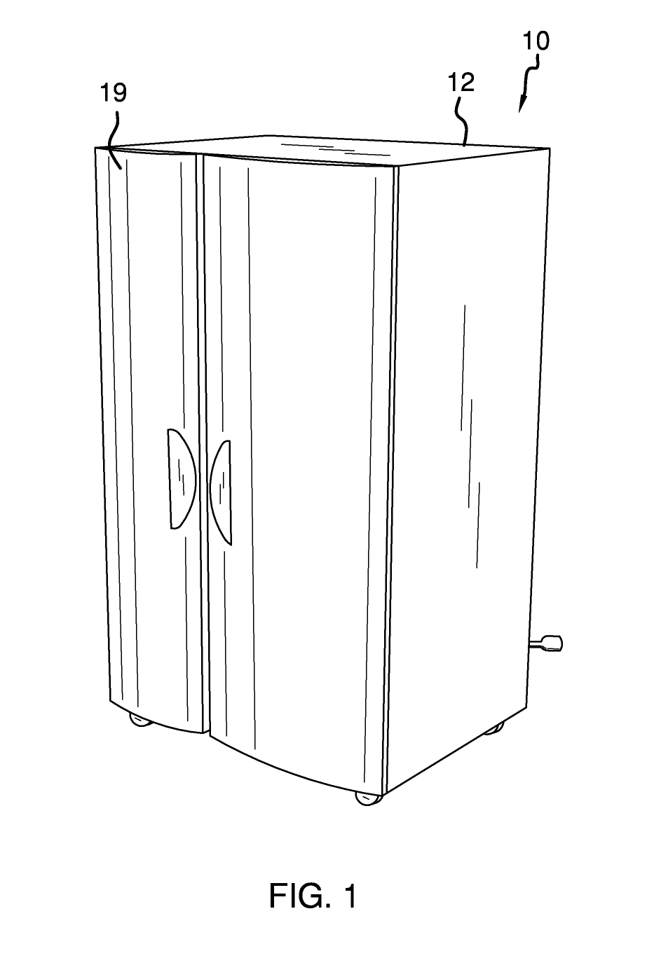

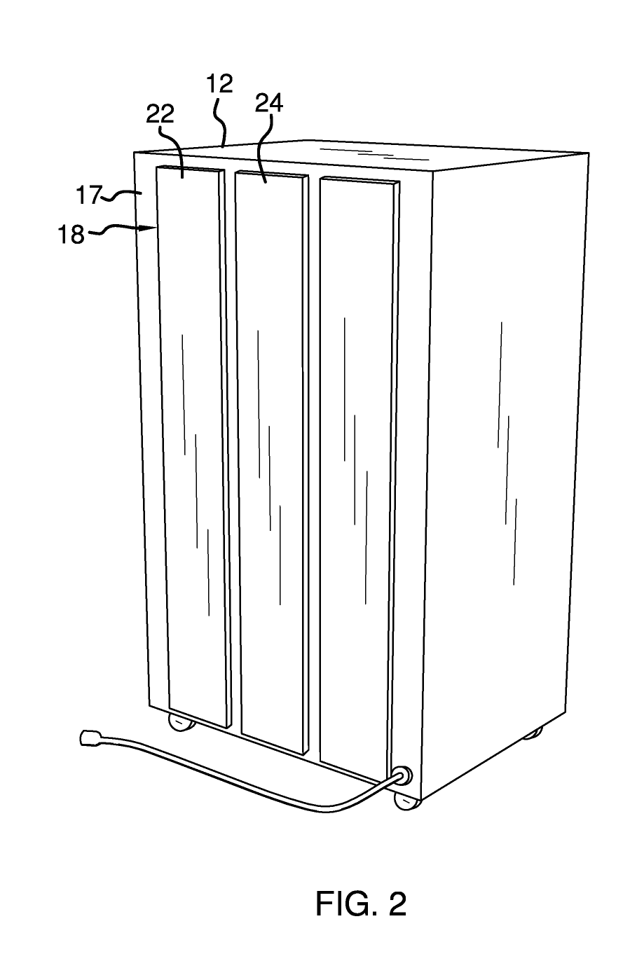

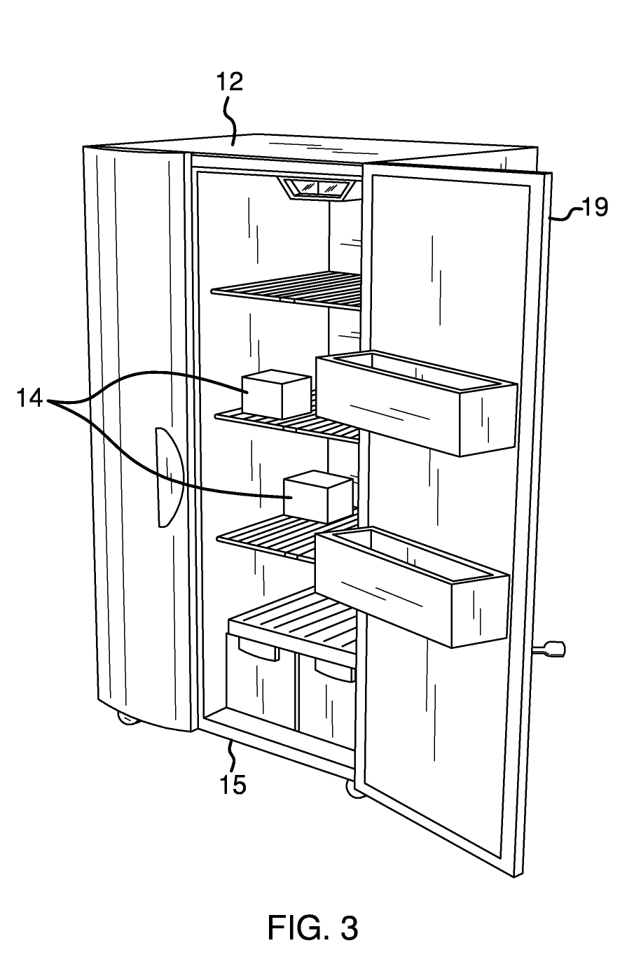

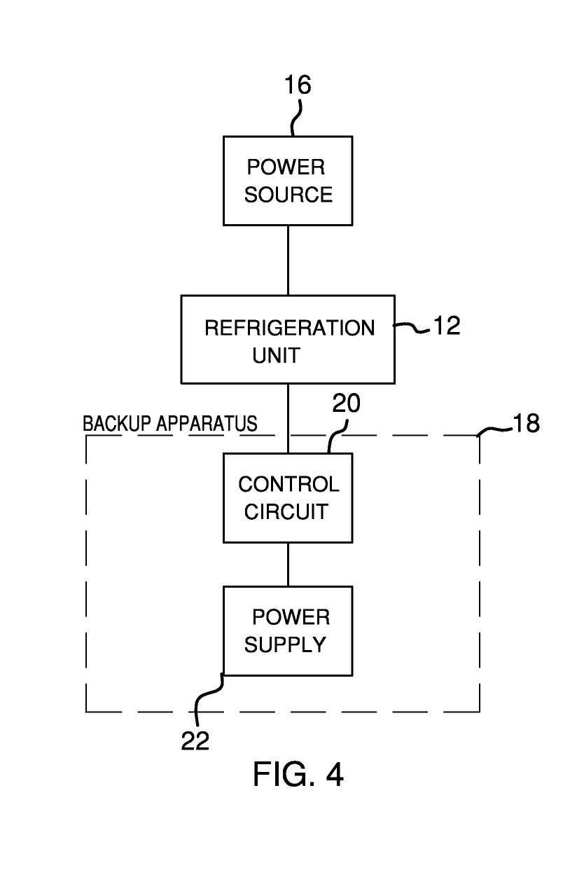

With reference now to the drawings, and in particular to FIGS. 1 through 4 thereof, a new emergency power device embodying the principles and concepts of an embodiment of the disclosure and generally designated by the reference numeral 10 will be described.

As best illustrated in FIGS. 1 through 4, the emergency power system 10 generally comprises a refrigeration unit 12 to contain food items 14. The refrigeration unit 12 maintains the food items 14 at a cooled temperature to preserve the food items 14 and the refrigeration 12 unit is electrically coupled to a power source 16. The cooled temperature may be a temperature ranging between 20° Fahrenheit and 40° Fahrenheit. The refrigeration unit 12 may be a household refrigerator, a commercial refrigerator or the like. The power source 16 may comprise an electrical outlet of any conventional design.

The refrigeration unit 12 has a front side 15 and a back side 17. The front side 15 is open to access an interior of the refrigeration unit 12. A door 19 is hingedly coupled to the front side 15 to close the front side 15. The door 19 may be one of a pair of doors 19.

A backup apparatus 18 provides electrical power to the refrigeration unit 12 in the event of failure of the power source 16 such that the refrigeration unit 12 maintains the food items 14 at the cooled temperature. The backup apparatus 18 comprises a control circuit 20 attached to the refrigeration unit 12 and the control circuit 20 is electrically coupled to the power source 16.

A power supply 22 is attached to the refrigeration unit 12. The power supply 22 is electrically coupled to the control circuit 20 and the refrigeration unit 12. The power supply 22 supplies electrical power to the refrigeration unit 12 when the control circuit 20 senses a failure of the power source 16. Moreover, the power supply 22 ceases supplying electrical power to the refrigeration unit when the control circuit senses the power source 16 is returned to service. The power supply 22 is charged by the power source 16 when the power source 16 is in service. The power supply 22 may comprise at least one battery 24 with a service life between 12 hours and 48 hours. The power supply 22 may be positioned on the back side 17.

In use, the refrigeration unit 12 is utilized in the convention of cold storage of the food items 14. The power supply 22 begins supplying electrical power to the refrigeration unit 12 in the event of a power outage or other similar event that results in the failure of the power source 16. The power supply 22 allows the refrigeration unit 12 to continue performing cold storage of the food items 14 in order to prevent spoilage of the food items 14 while the power source 16 is inoperative. The power source 16 recharges the power supply 22 after the power source 16 is returned to service.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An emergency power system configured to maintain cold storage of food items during a power outage, said system comprising:
a refrigeration unit configured to contain food items, said refrigeration unit maintaining the food items at a cooled temperature to preserve the food items, said refrigeration unit being electrically coupled to a power source; and
a backup apparatus providing electrical power to said refrigeration unit in the event of failure of the power source such that said refrigeration unit maintains the food items at the cooled temperature.

2. The assembly according to claim 1, wherein said backup apparatus comprises a control circuit attached to said refrigeration unit, said control circuit being configured to be electrically coupled to the power source.

3. The assembly according to claim 2, further comprising a power supply attached to said refrigeration unit, said power supply being electrically coupled to said control circuit, said power supply being electrically coupled to said refrigeration unit, said power supply comprising at least one battery.

4. The assembly according to claim 3, wherein said power supply supplies electrical power to said refrigeration unit when said control circuit senses a failure of the power source, said power supply ceasing supplying electrical power to said refrigeration unit when said control circuit senses the power source is returned to service, said power supply being configured to be charged by the power source when the power source is in service.

5. An emergency power system configured to maintain cold storage of food items during a power outage, said system comprising:
a refrigeration unit configured to contain food items, said refrigeration unit maintaining the food items at a cooled temperature to preserve the food items, said refrigeration unit being electrically coupled to a power source;
a backup apparatus providing electrical power to said refrigeration unit in the event of failure of the power source such that said refrigeration unit maintains the food items at the cooled temperature, said backup apparatus comprising:
a control circuit attached to said refrigeration unit, said control circuit being configured to be electrically coupled to the power source; and
a power supply attached to said refrigeration unit, said power supply being electrically coupled to said control circuit, said power supply being electrically coupled to said refrigeration unit, said power supply supplying electrical power to said refrigeration unit when said control circuit senses a failure of the power source, said power supply ceasing supplying electrical power to said refrigeration unit when said control circuit senses the power source is returned to service, said power supply being configured to be charged by the power source when the power source is in service, said power supply comprising at least one battery.
